(19) United States
(12) Patent Application Publication
(10) Pub. No.: US 2020/0359458 A1
(43) Pub. Date: Nov. 12, 2020

(54) SCRAMBLING SEQUENCE GENERATION AND PUSCH OCCASION MAPPING FOR 2-PART RACH

(71) Applicants: Gang Xiong, Beaverton, OR (US); Sergey Sosnin, Zavolzhie (RU); Lopamudra Kundu, Sunnyvale, CA (US); Seunghee Han, San Jose, CA (US)

(72) Inventors: Gang Xiong, Beaverton, OR (US); Sergey Sosnin, Zavolzhie (RU); Lopamudra Kundu, Sunnyvale, CA (US); Seunghee Han, San Jose, CA (US)

(21) Appl. No.: 16/942,871

(22) Filed: Jul. 30, 2020

Related U.S. Application Data
(60) Provisional application No. 62/887,530, filed on Aug. 15, 2019.
(60) Provisional application No. 62/898,299, filed on Sep. 10, 2019.
(60) Provisional application No. 62/910,966, filed on Oct. 4, 2019.

(51) Int. Cl. H04W 88/06; H04W 74/08; H04W 72/04; H04W 76/11; H04W 76/27

(52) U.S. Cl. CPC H04W 88/06; H04W 74/0833; H04W 72/0466; H04W 72/0446; H04W 76/27; H04W 72/0453; H04W 76/11

(57) ABSTRACT

An apparatus of a user equipment (UE) includes processing circuitry coupled to a memory, where to configure the UE for a 2-step random access procedure with a gNB in a 5G-NR communication network, the processing circuitry is to encode a first message (MsgA) for transmission to the gNB. The MsgA includes a random access preamble and a PUSCH payload. The PUSCH payload is scrambled based on a random access preamble index (RAPID) of the random access preamble and a random access-radio network temporary identifier (RA-RNTI). A second message (MsgB) received from the gNB in response to the MsgA is decoded. The MsgB includes a random access response (RAR), the RAR being one of a fallbackRAR or a successRAR.

### PRIORITY CLAIM

This application claims the benefit of priority to the following provisional applications:

U.S. Provisional Patent Application Ser. No. 62/887,530, filed Aug. 15, 2019, and entitled “SCRAMBLING SEQUENCE GENERATION AND PHYSICAL UPLINK SHARED CHANNEL (PUSCH) OCCASION MAPPING FOR 2-STEP RANDOM ACCESS CHANNEL (RACH)”;

U.S. Provisional Patent Application Ser. No. 62/898,299, Sep. 10, 2019, and entitled “SCRAMBLING SEQUENCE GENERATION AND PHYSICAL UPLINK SHARED CHANNEL (PUSCH) OCCASION MAPPING FOR 2-STEP RANDOM ACCESS CHANNEL (RACH)”; and

U.S. Provisional Patent Application Ser. No. 62/910,966, filed Oct. 4, 2019, and entitled “SCRAMBLING SEQUENCE GENERATION AND PHYSICAL UPLINK SHARED CHANNEL (PUSCH) OCCASION MAPPING FOR 2-STEP RANDOM ACCESS CHANNEL (RACH).”

Each of the provisional patent application identified above is incorporated herein by reference in its entirety.

### TECHNICAL FIELD

Aspects pertain to wireless communications. Some aspects relate to wireless networks including 3GPP (Third Generation Partnership Project) networks, 3GPP LTE (Long Term Evolution) networks, 3GPP LTE-A (LTE Advanced) networks, and fifth-generation (5G) networks including 5G new radio (NR) (or 5G-NR) networks and 5G-LTE networks such as 5G NR unlicensed spectrum (NR-U) networks. Other aspects are directed to systems and methods for scrambling sequence generation and physical uplink shared channel (PUSCH) occasion mapping for a 2-part (or 2-step) random access procedure.

### BACKGROUND

Mobile communications have evolved significantly from early voice systems to today's highly sophisticated integrated communication platform. With the increase in different types of devices communicating with various network devices, usage of 3GPP LTE systems has increased. The penetration of mobile devices (user equipment or UEs) in modern society has continued to drive demand for a wide variety of networked devices in many disparate environments. Fifth-generation (5G) wireless systems are forthcoming and are expected to enable even greater speed, connectivity, and usability. Next generation 5G networks (or NR networks) are expected to increase throughput, coverage, and robustness and reduce latency and operational and capital expenditures. 5G-NR networks will continue to evolve based on 3GPP LTE-Advanced with additional potential new radio access technologies (RATs) to enrich people's lives with seamless wireless connectivity solutions delivering fast, rich content and services. As current cellular network frequency is saturated, higher frequencies, such as millimeter wave (mmWave) frequency, can be beneficial due to their high bandwidth.

Potential LTE operation in the unlicensed spectrum includes (and is not limited to) the LTE operation in the unlicensed spectrum via dual connectivity (DC), or DC-based LAA, and the standalone LTE system in the unlicensed spectrum, according to which LTE-based technology solely operates in the unlicensed spectrum without requiring an “anchor” in the licensed spectrum, called MulteFire. MulteFire combines the performance benefits of LTE technology with the simplicity of Wi-Fi-like deployments.

Further enhanced operation of LTE systems in the licensed as well as unlicensed spectrum is expected in future releases and 5G systems. Such enhanced operations can include techniques for scrambling sequence generation and physical uplink shared channel (PUSCH) occasion mapping for a 2-part random access procedure.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various aspects discussed in the present document.

FIG. 1A illustrates an architecture of a network, in accordance with some aspects.

FIG. 1B and FIG. 1C illustrate a non-roaming 5G system architecture in accordance with some aspects.

FIG. 2 illustrates a swimlane diagram of a 2-step random access procedure, in accordance with some aspects.

FIG. 3 illustrates multiple PUSCH occasions in a slot for time-domain resource allocation, in accordance with some embodiments.

FIG. 4 illustrates multiple physical random access channel (PRACH) and PUSCH occasions in a slot for time-domain resource allocation, in accordance with some embodiments.

FIG. 5 illustrates multiple PUSCH occasions for frequency domain resource allocation, in accordance with some embodiments.

FIG. 6 illustrates a mapping between PRACH preamble and a MsgA PUSCH resource unit, in accordance with some embodiments.

FIG. 7 illustrates another mapping between PRACH preamble and a MsgA PUSCH resource unit, in accordance with some embodiments.

FIG. 8 illustrates a block diagram of a communication device such as an evolved Node-B (eNB), a new generation Node-B (gNB), an access point (AP), a wireless station (STA), a mobile station (MS), or user equipment (UE), in accordance with some aspects.

### DETAILED DESCRIPTION

The following description and the drawings sufficiently illustrate aspects to enable those skilled in the art to practice them. Other aspects may incorporate structural, logical, electrical, process, and other changes. Portions and features of some aspects may be included in or substituted for, those of other aspects. Aspects outlined in the claims encompass all available equivalents of those claims.

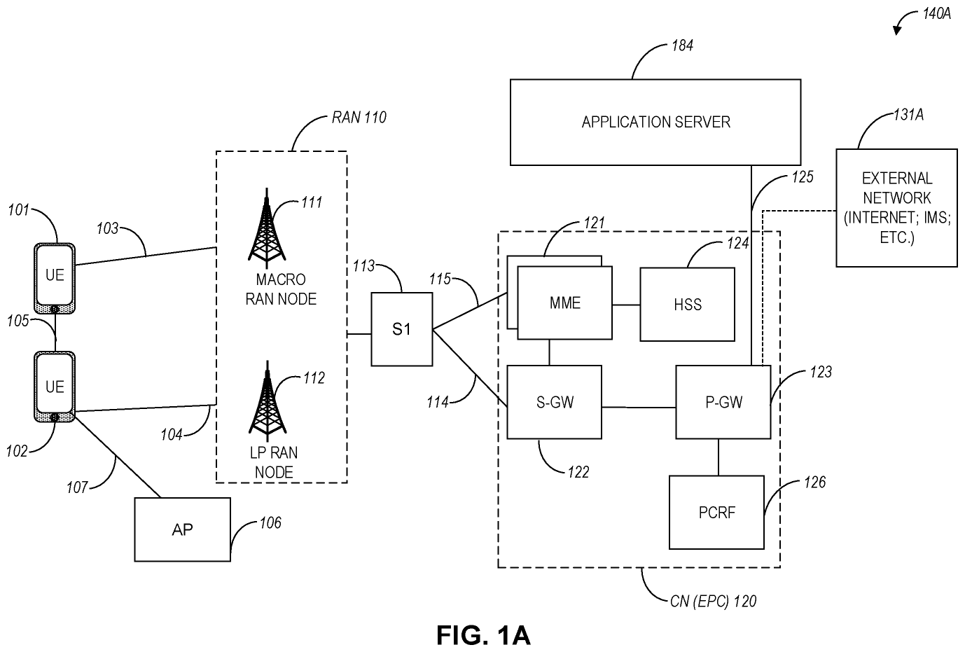

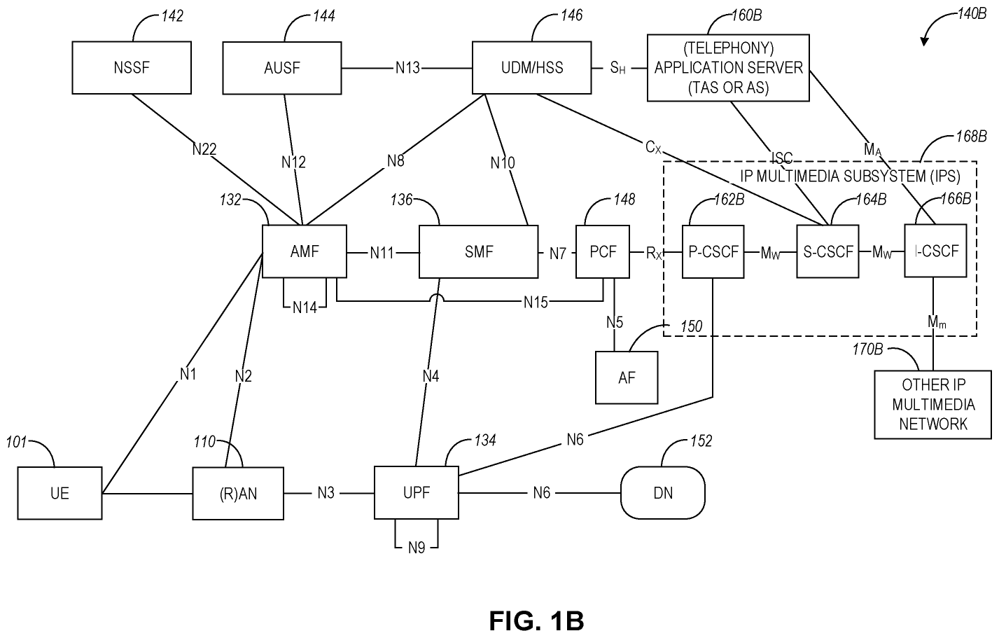

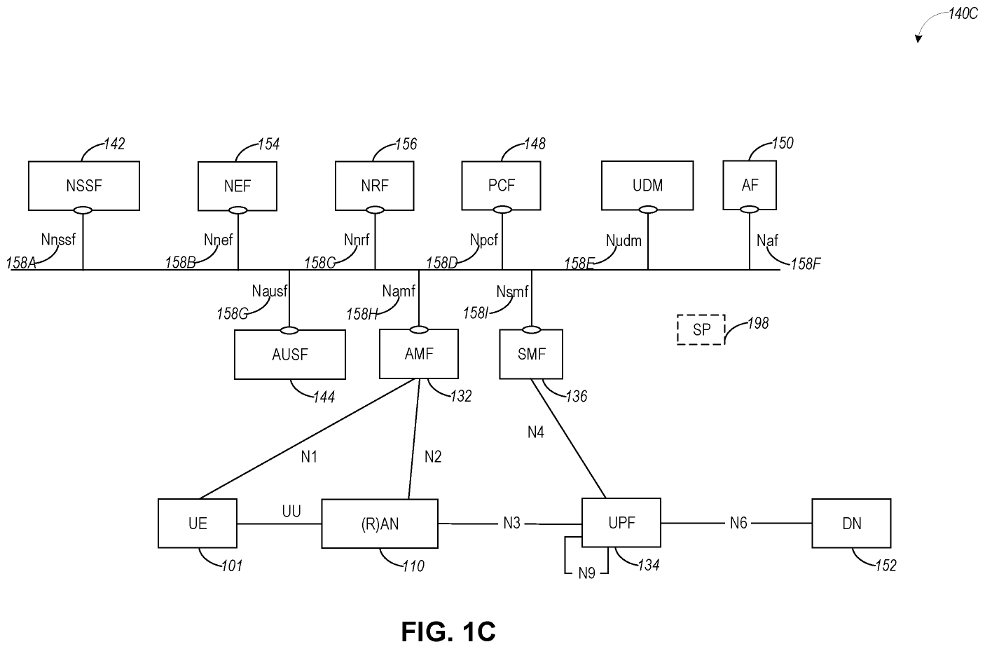

FIG. 1A illustrates an architecture of a network in accordance with some aspects. The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as Personal Data Assistants (PDAs), pagers, laptop computers, desktop computers, wireless handsets, drones, or any other computing device including a wired and/or wireless communications interface. The UEs 101 and 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard.

LTE and LTE-Advanced are standards for wireless communications of high-speed data for UE such as mobile telephones. In LTE-Advanced and various wireless systems, carrier aggregation is a technology according to which multiple carrier signals operating on different frequencies may be used to carry communications for a single UE, thus increasing the bandwidth available to a single device. In some aspects, carrier aggregation may be used where one or more component carriers operate on unlicensed frequencies.

Aspects described herein can be used in the context of any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and further frequencies and Spectrum Access System (SAS) in 3.55-3.7 GHz and further frequencies).

Aspects described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN. The UEs 101 and 102 utilize connections 103 and 104, respectively, each of which comprises a physical communications interface or layer (discussed in further detail below); in this example, the connections 103 and 104 are illustrated as an air interface to enable communicative coupling and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth-generation (5G) protocol, a New Radio (NR) protocol, and the like.

In an aspect, the UEs 101 and 102 may further directly exchange communication data via a ProSe interface 105. The ProSe interface 105 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 can be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and can be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 can be a new generation Node-B (gNB), an evolved node-B (eNB), or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the EPC network 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VoIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A can be an IoT network or a 5G network, including 5G new radio network using communications in the licensed (5G NR) and the unlicensed (5G NR-U) spectrum. One of the current enablers of IoT is the narrowband-IoT (NB-IoT).

An NG system architecture can include the RAN 110 and a 5G network core (5GC) 120. The NG-RAN 110 can include a plurality of nodes, such as gNBs and NG-eNBs. The core network 120 (e.g., a 5G core network or 5GC) can include an access and mobility function (AMF) and/or a user plane function (UPF). The AMF and the UPF can be communicatively coupled to the gNBs and the NG-eNBs via NG interfaces. More specifically, in some aspects, the gNBs and the NG-eNBs can be connected to the AMF by NG-C interfaces, and to the UPF by NG-U interfaces. The gNBs and the NG-eNBs can be coupled to each other via Xn interfaces.

In some aspects, the NG system architecture can use reference points between various nodes as provided by 3GPP Technical Specification (TS) 23.501 (e.g., V15.4.0, 2018 December). In some aspects, each of the gNBs and the NG-eNBs can be implemented as a base station, a mobile edge server, a small cell, a home eNB, and so forth. In some aspects, a gNB can be a master node (MN) and NG-eNB can be a secondary node (SN) in a 5G architecture.

FIG. 1B illustrates a non-roaming 5G system architecture in accordance with some aspects. Referring to FIG. 1B, there is illustrated a 5G system architecture 140B in a reference point representation. More specifically, UE 102 can be in communication with RAN 110 as well as one or more other 5G core (5GC) network entities. The 5G system architecture 140B includes a plurality of network functions (NFs), such as access and mobility management function (AMF) 132, session management function (SMF) 136, policy control function (PCF) 148, application function (AF) 150, user plane function (UPF) 134, network slice selection function (NSSF) 142, authentication server function (AUSF) 144, and unified data management (UDM)/home subscriber server (HSS) 146. The UPF 134 can provide a connection to a data network (DN) 152, which can include, for example, operator services, Internet access, or third-party services. The AMF 132 can be used to manage access control and mobility and can also include network slice selection functionality. The SMF 136 can be configured to set up and manage various sessions according to network policy. The UPF 134 can be deployed in one or more configurations according to the desired service type. The PCF 148 can be configured to provide a policy framework using network slicing, mobility management, and roaming (similar to PCRF in a 4G communication system). The UDM can be configured to store subscriber profiles and data (similar to an HSS in a 4G communication system).

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162BE, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain aspects of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some aspects, the I-CSCF 166B can be connected to another IP multimedia network 170E, e.g. an IMS operated by a different network operator.

In some aspects, the UDM/HSS 146 can be coupled to an application server 160E, which can include a telephony application server (TAS) or another application server (AS). The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures can be service-based and interaction between network functions can be represented by corresponding point-to-point reference points Ni or as service-based interfaces.

In some aspects, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

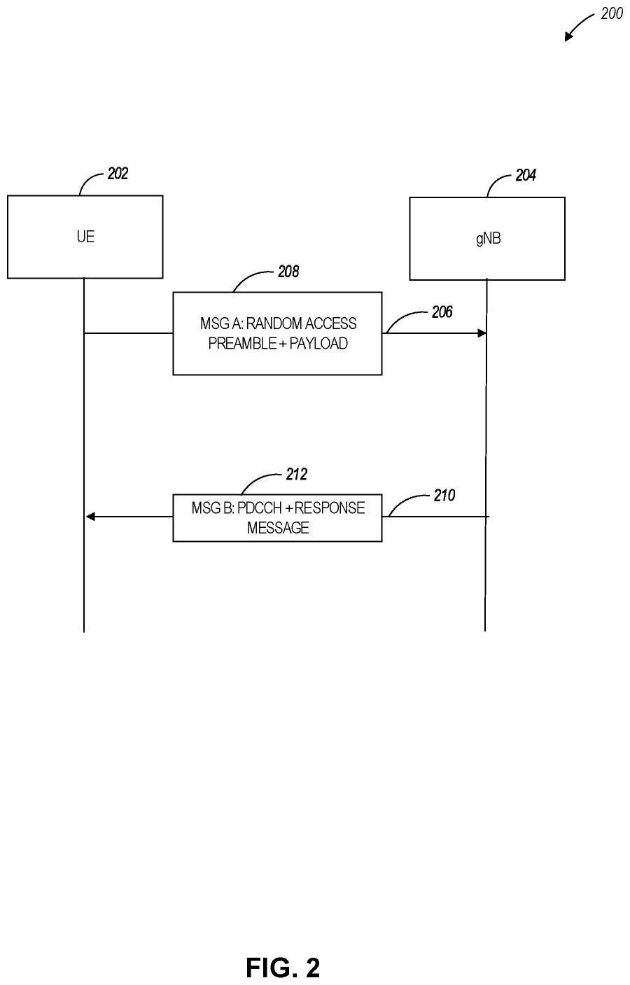

In some embodiments, any of the UEs or base stations described in connection with FIGS. 1A-1C can be configured to perform the functionalities described in connection with FIGS. 2-8.

Mobile communication has evolved significantly from early voice systems to today's highly sophisticated integrated communication platform. The next generation wireless communication system, 5G, or new radio (NR) will provide access to information and sharing of data anywhere, anytime by various users and applications. NR is expected to be a unified network/system that targets to meet vastly different and sometimes conflicting performance dimensions and services. Such diverse multi-dimensional requirements are driven by different services and applications. In general, NR will evolve based on 3GPP LTE-Advanced with additional potential new Radio Access Technologies (RATs) to enrich people's lives with better, simple, and seamless wireless connectivity solutions. NR will enable everything connected by wireless and deliver fast, rich content and services.

Rel-15 NR systems are designed to operate on the licensed spectrum. The NR-unlicensed (NR-U), a short-hand notation of the NR-based access to unlicensed spectrum, is a technology that enables the operation of NR systems on the unlicensed spectrum.

In NR, 4-step random access (RACH) procedure was defined. To reduce access latency, the RACH procedure may be simplified to allow fast access and low latency uplink transmission. To reduce the impact of listen-before-talk (LBT) on random access procedure over an unlicensed carrier, the following two approaches may be used: reduce the number of message exchange between the UE and the base station (e.g., gNB) or increase the transmission (TX) opportunities of each random access procedure (RACH) step. In particular, the 4-step RACH procedure may be reduced to 2-steps, where UE may combine Msg. 1 and Msg. 3 in the conventional RACH procedure for low latency PRACH transmission. The 2-step random access (RA) procedure uses the former approach. By reducing the number of RA steps, the number of LBTs is also reduced due to the reduced number of message exchanges between the UE and the gNB in the random access procedure.

FIG. 2 illustrates a swimlane diagram 200 of a 2-step random access procedure, in accordance with some aspects. In the first step, MsgA is composed of PRACH preamble and physical uplink shared channel (PUSCH) carrying payload which are multiplexed in a time-division multiplexing (TDM) manner. For instance, the payload may include the contents of Msg. 3 of 4-step RACH. In the second step, MsgB may include the contents of Msg. 2 and Msg. 4 of 4-step RACH. As used herein, the terms “MSG A” and “MsgA” are interchangeable. As used herein, the terms “MSG B” and MsgB” are interchangeable.

More specifically and referring to FIG. 2, the 2-step random access procedure takes place between a UE 202 and a gNB 204. At operation 206, the UE 202 communicates MSG A 208 to the gNB 204. MSG A 208 includes a random-access preamble and payload. Access preamble portion can be communicated via a physical random access channel (PRACH), and the payload portion may be communicated via a physical uplink shared channel (PUSCH). Both the PRACH and PUSCH of the MsgA should occur in the same Channel Occupancy Time with no gap or small gaps between them.

In response to MSG A 208, the gNB 204 communicates MSG B 212 at operation 210. MSG B 212 includes physical downlink control channel (PDCCH) information and a response message which can be communicated via a physical downlink shared channel (PDSCH). The PDSCH is for the case when MAC multiplexing is performed for one or more UEs.

In MSG A 208, the PRACH preamble may be used as reference signals for coherent detection of payload transmitted as well as for time alignment of the PUSCH if needed. The payload can be indicating the UE ID for contention resolution in Step 2 (MSG B) and for UE identification by the network in Step 1 (MSG A) in case of contention-based random access. In some aspects, the following triggers can be used to trigger the 2-step random access procedure illustrated in FIG. 2: initial access from RRC_IDLE; RRC Connection Re-establishment procedure; a handover; downlink (DL) or uplink (UL) data arrival during RRC_CONNECTED when UL synchronization status is “non-synchronized”; the transition from RRC_INACTIVE; to establish time alignment at a secondary cell (SCell) addition; request for Other system information (SI) (Msg3-based); and beam failure recovery.

In some aspects, the MSG A payload can be configured to carry at least one of the following RRC messages, a MAC control element (CE), or a combination of both: an RRC Setup Request message, an RRC Resume Request message, an RRC Reestablishment Request message, and MAC CE (e.g., cell radio network temporary identifier (C-RNTI) MAC CE, a buffer status report (BSR), a power headroom report (PHR)).

In MSG B 212, the gNB 204 may include the preamble ID (random access preamble ID or RAPID) for identification and may also include the UE ID for contention resolution in case of contention-based random access. To support the sending of the RRC Setup, Resume and Re-establishment messages, MSG B may be configured to also carry a payload for the RRC messages.

In some aspects, for 2-step RACH, the initialization seed for the scrambling sequence generation for MsgA PUSCH transmission can be determined based on a Radio Network Temporary Identifier (RNTI such as RA-RNTI), preamble index (e.g., RAPID), and/or n_ID (e.g., higher-layer parameter DataScramblingIdentity or cell ID). If both one to one and many to one mapping between preamble and PUSCH resource unit are supported, RNTI and preamble index for scrambling sequence generation can allow gNB to differentiate MsgA PUSCHs from different UEs in a shared MsgA PUSCH occasion.

Further, in the case when multiple PUSCH occasions are allocated in a slot in time-division multiplexing (TDM) manner, certain mechanisms may need to define to configure the time domain resource allocation of MsgA PUSCH occasions, especially considering the guard time between MsgA PUSCH occasions.

Techniques disclosed herein can be used for designing the scrambling sequence generation and mapping of PUSCH occasion for 2-step RACH. In particular, disclosed techniques can be used to configure scrambling sequence generation for MsgA PUSCH, the mapping between PRACH preamble and MsgA PUSCH resource unit, time-domain resource allocation of MsgA PUSCH occasion, and frequency domain resource allocation of MsgA PUSCH occasion.

In some aspects, the initialization seed for scrambling sequence generation for PUSCH transmission is defined as follows. The scrambling sequence generator shall be initialized with cᵢₙᵢₜ=n_{RNTI}·2¹⁵+n_{ID}, where n_{ID}∈{0, 1, . . . , 1023} equals the higher-layer parameter dataScramblingIdentityPUSCH if configured and the RNTI equals the C-RNTI, MCS-C-RNTI or CS-RNTI, and the transmission is not scheduled using DCI format 0_0 in a common search space; n_{ID}=N_{ID}^{cell} otherwise and where n_{RNTI} corresponds to the RNTI associated with the PUSCH transmission as described in clause 6.1 of 3GPP TS 38.214.

### Scrambling Sequence Generation for MsgA PUSCH

In some aspects, for 2-step RACH, the initialization seed for scrambling sequence generation for MsgA PUSCH can be determined based on a Radio Network Temporary Identifier (RNTI, such as RA-RNTI), preamble index (e.g., RAPID), and/or n_{ID}. If both one-to-one and many-to-one mapping between preamble and PUSCH resource units are supported, RNTI and preamble index for scrambling sequence generation can allow gNB to differentiate MsgA PUSCHs from different UEs in a shared MsgA PUSCH occasion.

Embodiments of initialization of a scrambling sequence generator for MsgA PUSCH are provided as follows:

In one embodiment of the invention, the scrambling sequence generator can be initialized with

cᵢₙᵢₜ=(c₀·n_{RNTI}+c₁·I_{preamble}+c₂·n_{ID})mod2³¹, where n_{ID} is configured via NR minimum system information (MSI), NR remaining minimum system information (RMSI), NR other system information (OSI), or radio resource control (RRC) signaling. If not configured, n_{ID}=n_{ID}^{cell}. The parameter n_{RNTI} can be RA-RNTI or MsgB-RNTI. Parameter I_{preamble}={0, 1, . . . , 63} is the PRACH preamble index (e.g., RAPID) of associated PRACH occasion. Parameters c₀, c₁ and c₂ are constants, which can be predefined in the specification. They can be represented in the following form cᵢ=2^{k}^{ᵢ}, where kᵢ is a non-negative integer, i={0, 1, 2}.

In one example, the scrambling sequence generator can be initialized with cᵢₙᵢₜ=((n_{RNTI}·2⁶+I_{preamble})·2¹⁰+n_{ID})mod2³¹.

In another example, the scrambling sequence generation can be initialized with cᵢₙᵢₜ=(n_{RNTI}·2¹⁶+n_{ID}·2⁶+I_{preamble})mod2³¹.

In another example, the scrambling sequence generation can be initialized with cᵢₙᵢₜ=((n_{RNTI}·2⁶+I_{preamble})·2¹⁵+n_{ID})mod2³¹.

Note that in the above equation, the mod2³¹ operation may not be needed. For instance, the scrambling sequence generator for scrambling PUSCH payload data for MsgA transmission can be initialized with cᵢₙᵢₜ=(n_{RNTI}·2⁶+I_{preamble})·2¹⁰+n_{ID}, where n_RNTI is the RA-RNTI, the I_preamble is the RAPID, and the n_ID is the data scrambling identity (or cell ID).

In another embodiment of the invention, a subset of the PRACH preamble index can be used for scrambling sequence generation of MsgA PUSCH. Assuming the maximum number of PRACH preambles associated with one PUSCH occasion as K, where K is predefined in the specification, e.g., K=32, 16, etc., the preamble index used for scrambling sequence generation of MsgA PUSCH can be I_{preamble}mod(K).

In one example, then the scrambling sequence generation can be initialized with cᵢₙᵢₜ=(n_{RNTI}·2⁵+I_{preamble}mod2⁵)·2¹⁰+n_{ID}.

In another example, the scrambling sequence generation can be initialized with cᵢₙᵢₜ=n_{RNTI}·2¹⁵+n_{ID}·2⁵+I_{preamble}mod2⁵.

In another example, the scrambling sequence generation can be initialized with cᵢₙᵢₜ=((n_{RNTI}·2⁵+I_{preamble}mod2⁵)·2¹⁵+n_{ID})mod2³¹. In some aspects, the mod2³¹ operation may not be needed.

In another embodiment, the MsgA PUSCH demodulation reference signal (DMRS) antenna port (AP) can be used for scrambling the sequence generation of MsgA PUSCH. In particular, the scrambling sequence generator can be initialized with cᵢₙᵢₜ=(c₀·n_{RNTI}+c₁·I_{preamble}+c₂·n_{ID}+c₃·I_{AP})mod2³¹, where I_{AP} is the DMRS AP index of corresponding MsgA PUSCH transmission; and c₃ is a constant, which can be predefined in the specification. It can be equal to 2^{k}, where k is a non-negative integer.

In one example, the scrambling sequence generator can be initialized with cᵢₙᵢₜ=((n_{RNTI}·2¹⁰+I_{AP}·2⁶+I_{preamble})·2¹⁰+n_{ID})mod2³¹.

In another example, the scrambling sequence generation can be initialized with cᵢₙᵢₜ=(n_{RNTI}·2²⁰+n_{ID}·2¹⁰+I_{AP}·2⁶+I_{preamble})mod2³¹.

In another example, the scrambling sequence generation can be initialized with cᵢₙᵢₜ=((n_{RNTI}·2¹⁰+I_{AP}·2⁶+I_{preamble})·2¹⁵+n_{ID})mod2³¹. In some aspects, the mod2³¹ operation may not be needed.

In some aspects, similar to the aforementioned technique, a subset of the PRACH preamble index together with DMRS AP can be used for scrambling sequence generation of MsgA PUSCH.

### Time Domain Resource Allocation of MsgA PUSCH Occasion

For 2-step RACH, when multiple PUSCH occasions are allocated in a slot in a TDM manner, certain mechanisms may need to be defined to configure the time domain resource allocation of MsgA PUSCH occasions, especially considering the guard time between MsgA PUSCH occasions.

Embodiments of time-domain resource allocation of MsgA PUSCH occasion are provided as follows:

In one embodiment, starting symbol and length indicator value (SLIV) of a first PUSCH occasion and the number of PUSCH occasions are configured by higher layer signaling, such as minimum system information (MSI), remaining MSI (RMSI), OSI, or RRC signaling. Also, guard time may be separately configured or derived from the PRACH configuration following the numerology of PRACH and PUSCH in MsgA. In some cases, guard time may not be needed.

In some aspects, the length of MsgA PUSCH occasions in a slot is the same.

In some aspects, based on the aforementioned parameters, the starting symbol of subsequent MsgA PUSCH occasions can be derived per the starting symbol of the first MsgA PUSCH occasion, the length of the MsgA PUSCH occasion in a slot, guard time if any. In particular, the starting symbol of the kth MsgA PUSCH occasions can be given by └(lₖ−l₀)mod(L_{PO}+Δ_{GT})┘=0 or (lₖ−l₀)mod(L_{PO}+Δ_{GT})=0, where lₖ is the starting symbol of kth MsgA PUSCH occasion, where k=1, . . . , N_{PO}−1 and N_{PO} is the number of PUSCH occasions in a slot; l₀ is the starting symbol of the first MsgA PUSCH occasion; L_{PO} is the length of the MsgA PUSCH occasion; and Δ_{GT} is the guard time for MsgA PUSCH transmission (in the same unit as L_{PO}).

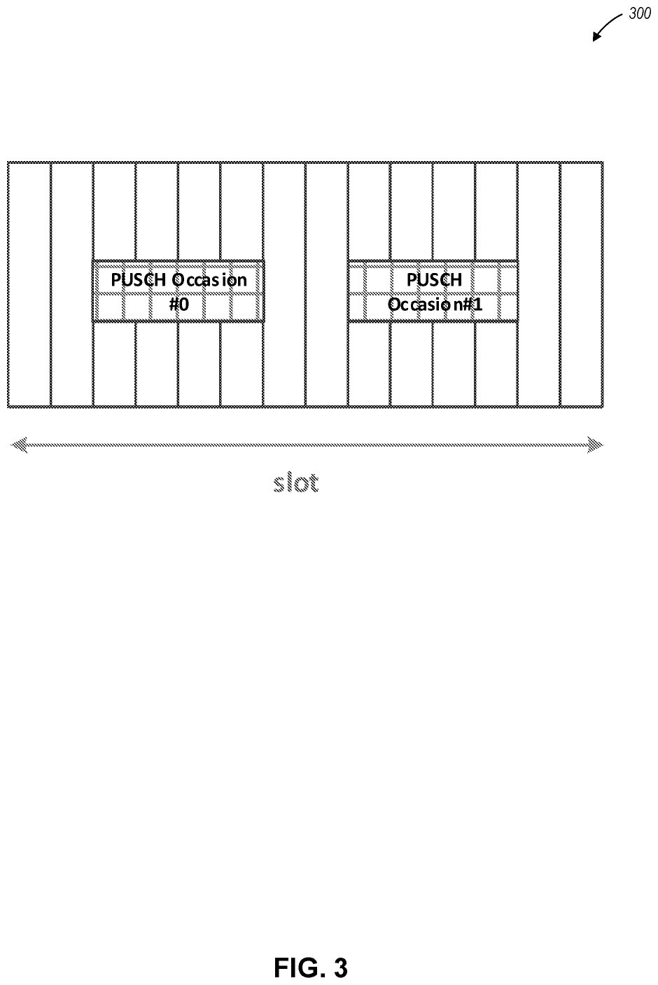

FIG. 3 illustrates a diagram 300 of multiple PUSCH occasions in a slot for time-domain resource allocation, in accordance with some embodiments. More specifically, FIG. 3 illustrates one example of MsgA PUSCH occasions in a slot. In the example, the length of MsgA PUSCH occasions is 4, i.e., L_{PO}=4, the number of PUSCH occasions in a slot is 2, i.e., N_{PO}=2, the starting symbol of the first PUSCH occasion l₀=2. The guard time is configured as Δ_{GT}=2 symbols. In this example, the starting symbol of second MsgA PUSCH can be derived as l₁=8.

In another embodiment, SLIV is configured for each MsgA PUSCH occasion in a slot.

In some aspects, the length of the MsgA PUSCH occasion may include the guard time. In this case, when transmitting the MsgA PUSCH, the UE would not transmit the MsgA PUSCH in the guard time. In another aspect, the length of the MsgA PUSCH occasion may not include the guard time. In this case, a parameter regarding the guard time may not be needed in the configuration of the MsgA PUSCH occasions.

In another aspect, a fixed guard time can be pre-configured (instead of being indicated as a part of SLIV), which would be applied to each MsgA occasion in a slot.

As shown in FIG. 3, the starting symbol and length of the first MsgA PUSCH occasion is configured as 2 and 4 symbols, and the starting symbol and length of the 2nd MsgA PUSCH occasion in the slot is configured as 8 and 4 symbols.

In another embodiment, SLIV may be used to indicate the starting symbol of the first MsgA PUSCH occasion and overall length of all MsgA PUSCH occasions in a slot. Based on the SLIV, guard time if any, and the number of MsgA PUSCH occasions, the starting symbol of the subsequent MsgA PUSCH can be derived accordingly.

Similar to the above techniques, the guard time may or may not be included in the overall length of all MsgA PUSCH occasions in a slot. Alternatively, guard time may be included only for the first MsgA PUSCH occasion in SLIV and the same guard time may be applied on all subsequent PUSCH occasions within a slot while deriving the subsequent SLIVs corresponding to other MsgA PUSCH occasions within a slot.

As shown in FIG. 3, SLIV may be used to indicate the starting symbol of the first MsgA PUSCH as 2 and length of all MsgA PUSCH occasions in a slot (including cumulative guard time) as 12. Considering the guard time as 2 symbols, and the number of PUSCH occasions as 2, the starting symbol of the 2nd MsgA PUSCH occasion can be derived as 8.

In another embodiment, for some application and use cases, e.g., NR unlicensed operation, it is desirable to allow MsgA PRACH and PUSCH to be transmitted continuously in the same slot. In this way, the number of LBT attempts can be potentially reduced and the success rate of random access can be improved.

In this case, the aforementioned methods can be extended to the case when MsgA PRACH and PUSCH are transmitted in the same slot. In this case, the SLIV may indicate the starting symbol and length of both PRACH and PUSCH in a slot or only MsgA PUSCH in a slot.

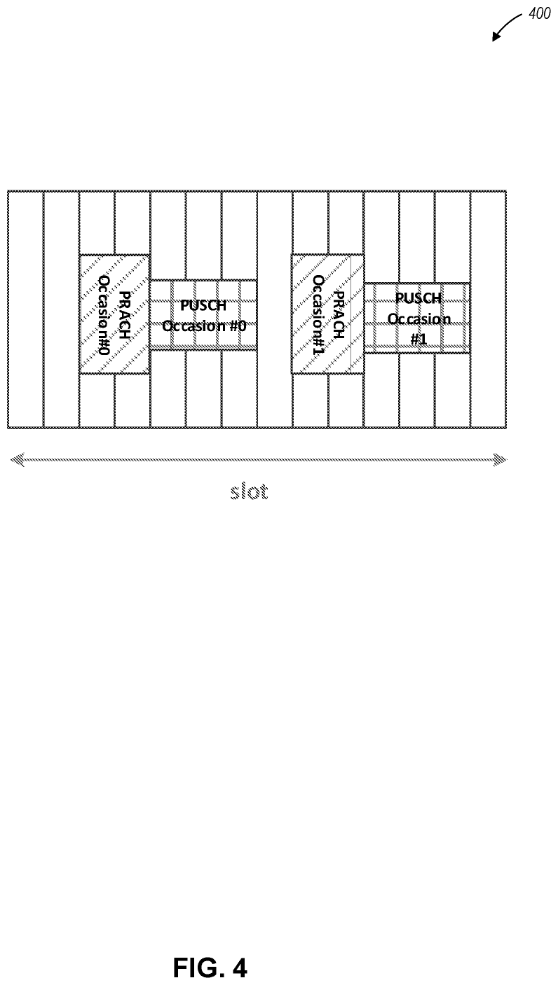

FIG. 4 illustrates a diagram 400 of multiple physical random access channel (PRACH) and PUSCH occasions in a slot for time-domain resource allocation, in accordance with some embodiments. More specifically, FIG. 4 illustrates one example of MsgA PRACH-PUSCH occasions in a slot. In the example, the guard time is 1 symbol. The starting symbol and length of the first MsgA PUSCH occasion is configured as 4 and 3 symbols; the starting symbol and length of the 2nd MsgA PUSCH occasion in the slot is configured as 10 and 3 symbols.

### Frequency Domain Resource Allocation of MsgA PUSCH Occasion

For 2-step RACH, when multiple PUSCH occasions are allocated in a slot in a frequency division multiplexing (FDM) manner, certain mechanisms may need to be defined to configure the frequency domain resource allocation of MsgA PUSCH occasions, especially considering the guard band between MsgA PUSCH occasions. Embodiments of frequency domain resource allocations of MsgA PUSCH occasions are provided as follows:

In one embodiment, a starting PRB and length indication value of a first PUSCH occasion, which is based on RIV (resource indicator value) and the number of PUSCH occasions in frequency for a MsgA PUSCH configuration are configured by higher layers via MSI, RMSI, OSI, or RRC signaling. Also, the guard band may be separately configured or derived from the PRACH configuration following the numerology of PRACH and PUSCH in MsgA. In some aspects, a guard band may not be needed.

In some aspects, the size of MsgA PUSCH occasions in frequency for a MsgA PUSCH configuration may be the same.

In some aspects, based on the aforementioned parameters, the starting PRB of subsequent MsgA PUSCH occasions in the same MsgA PUSCH configuration can be derived in accordance with the starting PRB of the first MsgA PUSCH occasion, the size of the MsgA PUSCH occasion in frequency, guard band if any. In particular, the starting PRB of the kth MsgA PUSCH occasions can be given by └(nₖ−n₀)mod(RB_{PO}+Δ_{GB})┘=0 or (nₖ−n₀)mod(RB_{PO}+Δ_{GB})=0, where nₖ is the starting PRB of kth MsgA PUSCH occasion, where k=1, . . . M_{PO}−1 and M_{PO} is the number of PUSCH occasions in frequency for a MsgA PUSCH configuration; n₀ is the starting PRB of the first MsgA PUSCH occasion; RB_{PO} is the PRB size of the MsgA PUSCH occasion; and Δ_{GB} is the guard band for MsgA PUSCH transmission.

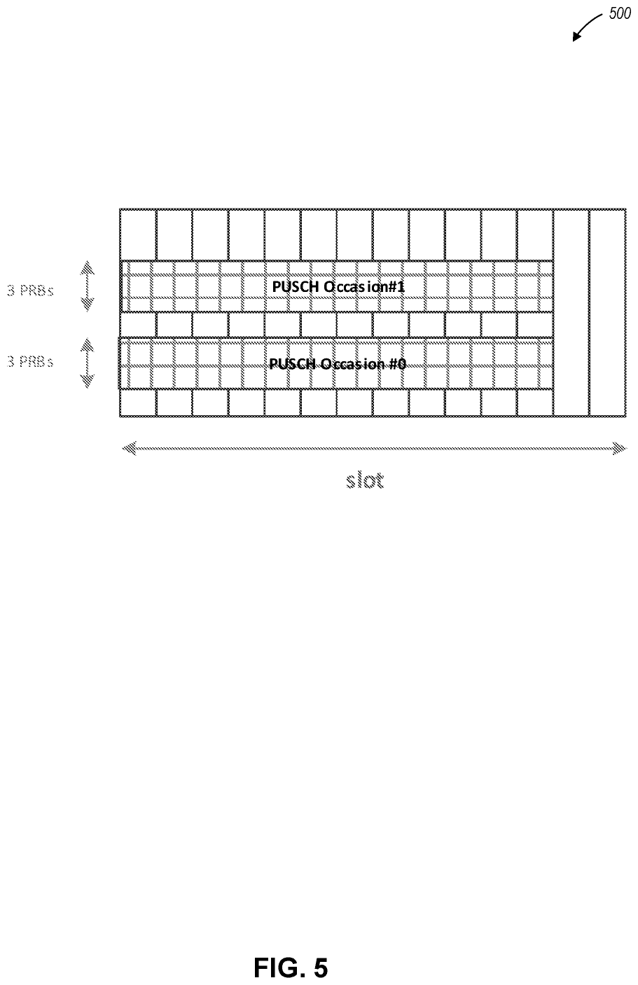

FIG. 5 illustrates a diagram 500 of multiple PUSCH occasions for frequency domain resource allocation, in accordance with some embodiments. More specifically, FIG. 5 illustrates one example of MsgA PUSCH occasions in a slot. In the example, the PRB size of MsgA PUSCH occasions is 3, i.e., RB_{PO}=3, the number of PUSCH occasions in frequency is 2, i.e., M_{PO}=2, the starting PRB of the first PUSCH occasion n₀=2. The guard band is configured as Δ_{GB}=1 PRB. In this example, the starting PRB of second MsgA PUSCH can be derived as n₁=6.

In another embodiment, RIV may be used to indicate the starting PRB of the first MsgA PUSCH occasion and overall PRB size of all MsgA PUSCH occasions in frequency for a MsgA PUSCH configuration. Based on the RIV, guard band if any, and the number of MsgA PUSCH occasions in frequency, the starting PRB of the subsequent MsgA PUSCH occasions can be derived accordingly.

### Mapping Between PRACH Preamble and MsgA PUSCH Resource Unit

In some aspects, to further increase the capacity of MsgA PUSCH transmission, it may be desirable to allow different Tx beams or spatial filters to be associated with the same MsgA PUSCH occasions. In this case, the gNB which is equipped with multiple panels may decode the multiple MsgA PUSCHs from different UEs with different Tx beams simultaneously. In this regard, certain mechanisms on the mapping between PRACH preamble and MsgA PUSCH resource unit may need to be defined.

Embodiments of mapping between PRACH preamble and MsgA PUSCH resource unit are provided as follows:

In one embodiment, PRACH preambles that are associated with different synchronization signal blocks (SSB) may be mapped to the same MsgA PUSCH resource unit.

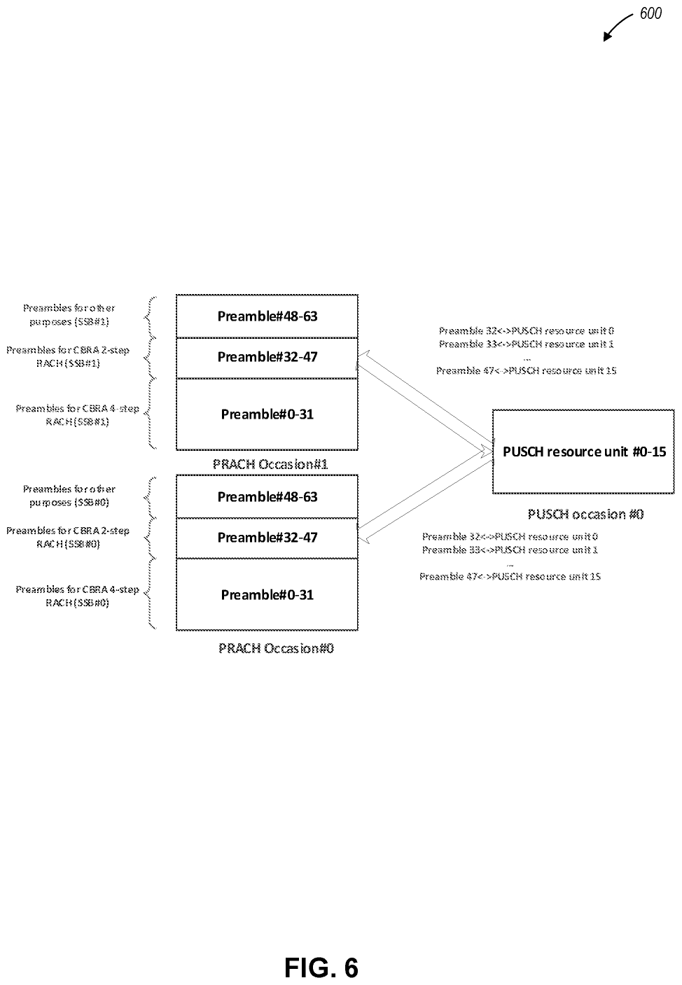

FIG. 6 illustrates a mapping 600 between PRACH preamble and a MsgA PUSCH resource unit, in accordance with some embodiments. More specifically, FIG. 6 illustrates one example of mapping between the PRACH preamble and the MsgA PUSCH resource unit. In the example of FIG. 6, SSB #0 is associated with PRACH occasion #0 and SSB #1 is associated with PRACH occasion #1. Further, the number of preambles for 4-step and 2-step RACH is configured as 32 and 16, respectively. In this case, preamble index #32-47 from PRACH occasion #0 and #1 are one-to-one mapped to PUSCH resource unit #0-15 in MsgA PUSCH occasion #0.

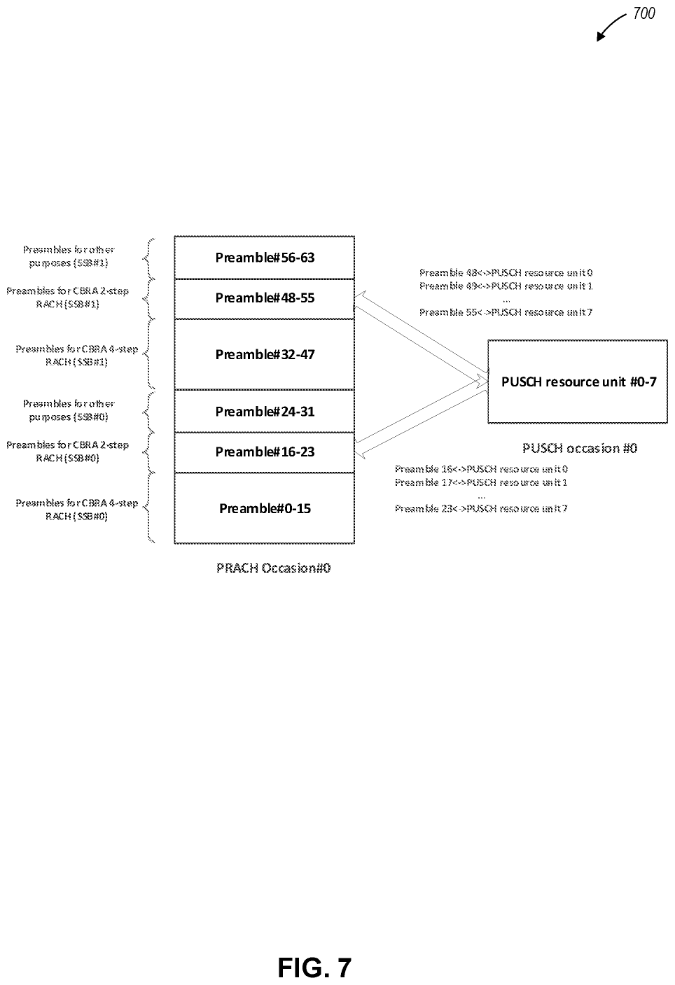

FIG. 7 illustrates another mapping 700 between PRACH preamble and a MsgA PUSCH resource unit, in accordance with some embodiments. More specifically, FIG. 7 illustrates another example of mapping between PRACH preamble and MsgA PUSCH resource unit. In the example of FIG. 7, SSB #0 and SSB #1 are associated with PRACH occasion #0. Further, the number of preambles for 4-step and 2-step RACH is configured as 16 and 8, respectively. In this case, preamble index #16-23 associated with SSB #0 and preamble index #48-55 associated with SSB #1 from PRACH occasion #0 are one-to-one mapped to PUSCH resource unit #0-7 in MsgA PUSCH occasion #0.

In some embodiments, a system and method of wireless communication for a 5G or NR system, the UE determines a Random Access-Radio Network Temporary Identifier (RA-RNTI) or MsgB-RNTI and a preamble index of associated physical random access channel (PRACH) in MsgA. In some aspects, the UE generates a scrambling sequence of MsgA physical uplink shared channel (PUSCH) in accordance with the RA-RNTI or MsgB-RNTI and the preamble index of the associated MsgA PRACH. In some aspects, the scrambling sequence generator can be initialized with cᵢₙᵢₜ=(c₀·n_{RNTI}+c₁·I_{preamble}+c₂·n_{ID})mod2³¹, where n_{ID} is configured via NR minimum system information (MSI), NR remaining minimum system information (RMSI), NR other system information (OSI), or radio resource control (RRC) signaling. If not configured, n_{ID}=n_{ID}^{cell}; n_{RNTI} can be RA-RNTI or MsgB-RNTI. I_{preamble}={0, 1, . . . , 63} is the PRACH preamble index of associated PRACH occasion; c₀, c₁ and c₂ are constants, which can be predefined in the specification.

In some aspects, a scrambling sequence generator can be initialized with cᵢₙᵢₜ=((n_{RNTI}·2⁶+I_{preamble})·2¹⁰+n_{ID})mod2³¹. In some aspects, the scrambling sequence generator can be initialized with cᵢₙᵢₜ=(n_{RNTI}·2¹⁶+n_{ID}·2⁶+I_{preamble})mod2³¹. In some aspects, a subset of the PRACH preamble index can be used for scrambling sequence generation of MsgA PUSCH. In some aspects, the MsgA PUSCH demodulation reference signal (DMRS) antenna port (AP) can be used for scrambling sequence generation of MsgA PUSCH. In some aspects, starting symbol and length indicator value (SLIV) of first PUSCH occasion and the number of PUSCH occasions are configured by higher layers via MSI, RMSI, OSI, or RRC signaling. In some aspects, the starting symbol of subsequent MsgA PUSCH occasions can be derived in accordance with the starting symbol of the first MsgA PUSCH occasion, the length of the MsgA PUSCH occasion in a slot, guard time if any.

In some aspects, SLIV is configured for each MsgA PUSCH occasion in a slot. In some aspects, SLIV may be used to indicate the starting symbol of the first MsgA PUSCH occasion and the overall length of all MsgA PUSCH occasions in a slot. In some aspects, the aforementioned methods can be extended to the case when MsgA PRACH and PUSCH are transmitted in the same slot. In some aspects, PRACH preambles that are associated with different synchronization signal blocks (SSB) may be mapped to the same MsgA PUSCH resource unit. In some aspects, starting PRB and length indication value of first PUSCH occasion, which is based on RIV (resource indicator value) and the number of PUSCH occasions in frequency for a MsgA PUSCH configuration is configured by higher layers via MSI, RMSI, OSI or RRC signaling. In some aspects, RIV may be used to indicate the starting PRB of the first MsgA PUSCH occasion and overall PRB size of all MsgA PUSCH occasions in frequency for a MsgA PUSCH configuration

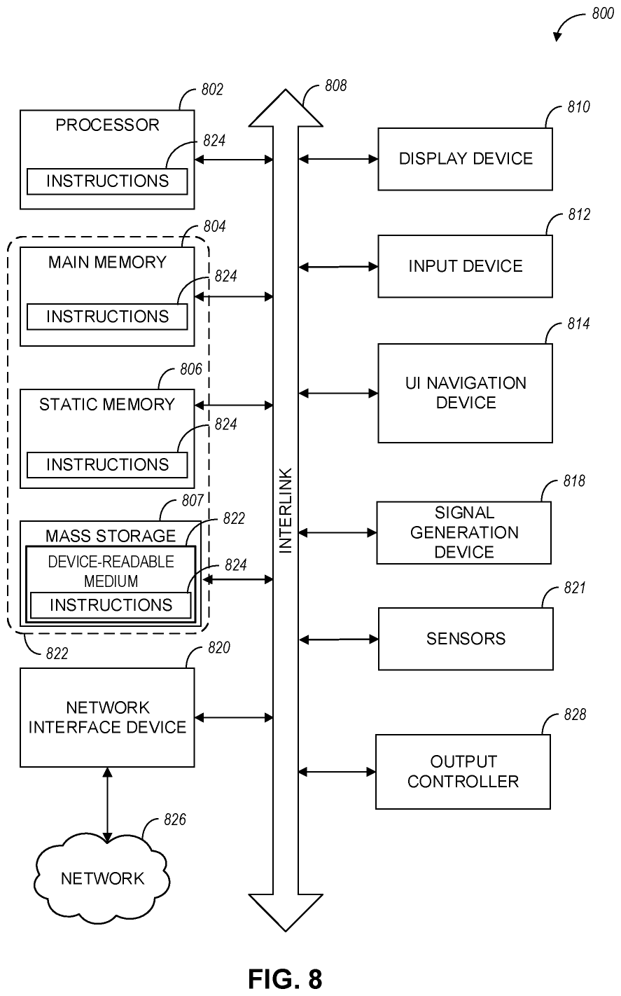

FIG. 8 illustrates a block diagram of a communication device such as an evolved Node-B (eNB), a next generation Node-B (gNB), an access point (AP), a wireless station (STA), a mobile station (MS), or user equipment (UE), in accordance with some aspects and to perform one or more of the techniques disclosed herein. In alternative aspects, the communication device 800 may operate as a standalone device or may be connected (e.g., networked) to other communication devices.

Circuitry (e.g., processing circuitry) is a collection of circuits implemented in tangible entities of the device 800 that include hardware (e.g., simple circuits, gates, logic, etc.). Circuitry membership may be flexible over time. Circuitries include members that may, alone or in combination, perform specified operations when operating. In an example, the hardware of the circuitry may be immutably designed to carry out a specific operation (e.g., hardwired). In an example, the hardware of the circuitry may include variably connected physical components (e.g., execution units, transistors, simple circuits, etc.) including a machine-readable medium physically modified (e.g., magnetically, electrically, moveable placement of invariant massed particles, etc.) to encode instructions of the specific operation.

In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the device 800 follow.

In some aspects, the device 800 may operate as a standalone device or may be connected (e.g., networked) to other devices. In a networked deployment, the communication device 800 may operate in the capacity of a server communication device, a client communication device, or both in server-client network environments. In an example, the communication device 800 may act as a peer communication device in peer-to-peer (P2P) (or other distributed) network environment. The communication device 800 may be a UE, eNB, PC, a tablet PC, an STB, a PDA, a mobile telephone, a smartphone, a web appliance, a network router, switch or bridge, or any communication device capable of executing instructions (sequential or otherwise) that specify actions to be taken by that communication device. Further, while only a single communication device is illustrated, the term “communication device” shall also be taken to include any collection of communication devices that individually or jointly execute a set (or multiple sets) of instructions to perform any one or more of the methodologies discussed herein, such as cloud computing, software as a service (SaaS), and other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a communication device-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using the software, the general-purpose hardware processor may be configured as respective different modules at different times. The software may accordingly configure a hardware processor, for example, to constitute a particular module at one instance of time and to constitute a different module at a different instance of time.

The communication device (e.g., UE) 800 may include a hardware processor 802 (e.g., a central processing unit (CPU), a graphics processing unit (GPU), a hardware processor core, or any combination thereof), a main memory 804, a static memory 806, and mass storage 807 (e.g., hard drive, tape drive, flash storage, or other block or storage devices), some or all of which may communicate with each other via an interlink (e.g., bus) 808.

The communication device 800 may further include a display device 810, an alphanumeric input device 812 (e.g., a keyboard), and a user interface (UI) navigation device 814 (e.g., a mouse). In an example, the display device 810, input device 812, and UI navigation device 814 may be a touchscreen display. The communication device 800 may additionally include a signal generation device 818 (e.g., a speaker), a network interface device 820, and one or more sensors 821, such as a global positioning system (GPS) sensor, compass, accelerometer, or another sensor. The communication device 800 may include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 807 may include a communication device-readable medium 822, on which is stored one or more sets of data structures or instructions 824 (e.g., software) embodying or utilized by any one or more of the techniques or functions described herein. In some aspects, registers of the processor 802, the main memory 804, the static memory 806, and/or the mass storage 807 may be, or include (completely or at least partially), the device-readable medium 822, on which is stored the one or more sets of data structures or instructions 824, embodying or utilized by any one or more of the techniques or functions described herein. In an example, one or any combination of the hardware processor 802, the main memory 804, the static memory 806, or the mass storage 816 may constitute the device-readable medium 822.

As used herein, the term “device-readable medium” is interchangeable with “computer-readable medium” or “machine-readable medium”. While the communication device-readable medium 822 is illustrated as a single medium, the term “communication device-readable medium” may include a single medium or multiple media (e.g., a centralized or distributed database, and/or associated caches and servers) configured to store the one or more instructions 824. The term “communication device-readable medium” is inclusive of the terms “machine-readable medium” or “computer-readable medium”, and may include any medium that is capable of storing, encoding, or carrying instructions (e.g., instructions 824) for execution by the communication device 800 and that cause the communication device 800 to perform any one or more of the techniques of the present disclosure, or that is capable of storing, encoding or carrying data structures used by or associated with such instructions. Non-limiting communication device-readable medium examples may include solid-state memories and optical and magnetic media. Specific examples of communication device-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, communication device-readable media may include non-transitory communication device-readable media. In some examples, communication device-readable media may include communication device-readable media that is not a transitory propagating signal.

The instructions 824 may further be transmitted or received over a communications network 826 using a transmission medium via the network interface device 820 utilizing any one of a number of transfer protocols. In an example, the network interface device 820 may include one or more physical jacks (e.g., Ethernet, coaxial, or phone jacks) or one or more antennas to connect to the communications network 826. In an example, the network interface device 820 may include a plurality of antennas to wirelessly communicate using at least one of single-input-multiple-output (SIMO), MIMO, or multiple-input-single-output (MISO) techniques. In some examples, the network interface device 820 may wirelessly communicate using Multiple User MIMO techniques.

The term “transmission medium” shall be taken to include any intangible medium that is capable of storing, encoding or carrying instructions for execution by the communication device 800, and includes digital or analog communications signals or another intangible medium to facilitate communication of such software. In this regard, a transmission medium in the context of this disclosure is a device-readable medium.

Although an aspect has been described with reference to specific exemplary aspects, it will be evident that various modifications and changes may be made to these aspects without departing from the broader scope of the present disclosure. Accordingly, the specification and drawings are to be regarded in an illustrative rather than a restrictive sense. This Detailed Description, therefore, is not to be taken in a limiting sense, and the scope of various aspects is defined only by the appended claims, along with the full range of equivalents to which such claims are entitled.

What is claimed is:

1. An apparatus to be used in a user equipment (UE), the apparatus comprising:
processing circuitry, wherein to configure the UE for a 2-step random access procedure with a next generation Node-B (gNB) in a 5G-New Radio (NR) communication network, the processing circuitry is to:
encode a first message (MsgA) for transmission to the gNB, the MsgA including a random access preamble triggering the 2-step random access procedure and a physical uplink shared channel (PUSCH) payload, the PUSCH payload scrambled based on a random access preamble index (RAPID) of the random access preamble; and
decode a second message (MsgB) received from the gNB in response to the MsgA, the MsgB including a random access response (RAR), the RAR being one of a fallbackRAR or a successRAR; and
a memory coupled to the processing circuitry and configured to store the RAR.

2. The apparatus of claim 1, wherein the processing circuitry is to:
scramble the PUSCH payload before encoding the MsgA, the scrambling using a scrambling sequence based on the RAPID, and a random access radio network temporary identifier (RA-RNTI) associated with the gNB.

3. The apparatus of claim 2, wherein the scrambling sequence is further based on a data scrambling identity configured to the UE via radio resource control (RRC) signaling.

4. The apparatus of claim 3, wherein the scrambling sequence is c_init=(n_RNTI·2\hat{ }6+I_preamble)·2\hat{ }10+n_ID, where n_RNTI is the RA-RNTI, the I_preamble is the RAPID, and the n_ID is the data scrambling identity.

5. The apparatus of claim 1, wherein the processing circuitry is to:
decode radio resource control (RRC) signaling, the RRC signaling including a starting symbol, and length indicator value (SLIV) of time-domain resource allocation for transmission of the MsgA.

6. The apparatus of claim 5, wherein the SLIV indicates a starting symbol and a length of a first PUSCH occasion of the time domain resource allocation within a slot.

7. The apparatus of claim 6, wherein the RRC signaling further indicates a number of PUSCH occasions within the slot, the number of PUSCH occasions forming the time domain resource allocation.

8. The apparatus of claim 7, wherein each of the PUSCH occasions within the slot is of equal size.

9. The apparatus of claim 1, wherein the processing circuitry is to:
decode radio resource control (RRC) signaling, the RRC signaling including a starting resource block, and a length of a first PUSCH occasion of a frequency domain resource allocation for transmission of the MsgA.

10. The apparatus of claim 9, wherein the RRC signaling further indicates a number of consecutive PUSCH occasions, including the first PUSCH occasion, of the frequency domain resource allocation for the transmission of the MsgA.

11. The apparatus of claim 1, further comprising transceiver circuitry coupled to the processing circuitry; and, one or more antennas coupled to the transceiver circuitry.

12. A non-transitory computer-readable storage medium that stores instructions for execution by one or more processors of a next generation Node-B (gNB), the instructions to configure the gNB for a 2-step random access procedure with a user equipment (UE) in a 5G-New Radio (NR) communication network, and to cause the gNB to:
decode a first message (MsgA) received from the UE, the MsgA including a random access preamble triggering the 2-step random access procedure and a physical uplink shared channel (PUSCH) payload, the PUSCH payload scrambled based on a random access preamble index (RAPID) of the random access preamble; and
encode a second message (MsgB) for transmission to the UE in response to the MsgA, the MsgB including a random access response, the RAR being one of a fallbackRAR or a successRAR.

13. The computer-readable storage medium of claim 12, wherein the instructions further cause the gNB to:
encode radio resource control (RRC) signaling, the RRC signaling including a starting symbol, and length indicator value (SLIV) of a time-domain resource allocation for transmission of the MsgA.

14. The computer-readable storage medium of claim 13, wherein the SLIV indicates a starting symbol and a length of a first PUSCH occasion of the time domain resource allocation within a slot.

15. The computer-readable storage medium of claim 14, wherein the RRC signaling further indicates a number of PUSCH occasions within the slot, the number of PUSCH occasions forming the time domain resource allocation.

16. A non-transitory computer-readable storage medium that stores instructions for execution by one or more processors of a user equipment (UE), the instructions to configure the UE for a 2-step random access procedure with a next generation Node-B (gNB) in a 5G-New Radio (NR) communication network, and to cause the UE to:
encode a first message (MsgA) for transmission to the gNB, the MsgA including a random access preamble triggering the 2-step random access procedure and a physical uplink shared channel (PUSCH) payload, the PUSCH payload scrambled based on a random access preamble index (RAPID) of the random access preamble; and
decode a second message (MsgB) received from the gNB in response to the MsgA, the MsgB including a random access response (RAR), the RAR being one of a fallbackRAR or a successRAR.

17. The computer-readable storage medium of claim 16, wherein the instructions further cause the UE to:
scramble the PUSCH payload before encoding the MsgA, the scrambling using a scrambling sequence based on the RAPID, and a random access radio network temporary identifier (RA-RNTI) associated with the gNB.

18. The computer-readable storage medium of claim 17, wherein the scrambling sequence is further based on a data scrambling identity configured to the UE via radio resource control (RRC) signaling.

19. The computer-readable storage medium of claim 18, wherein the scrambling sequence is c_init=(n_RNTI·2\hat{ }6+I_preamble)·2\hat{ }10+n_ID, where n_RNTI is the RA-RNTI, the I_preamble is the RAPID, and the n_ID is the data scrambling identity.

20. The computer-readable storage medium of claim 16, wherein the instructions further cause the UE to:
decode radio resource control (RRC) signaling, the RRC signaling including a starting symbol and length indicator value (SLIV) of a time-domain resource allocation for transmission of the MsgA,
wherein the SLIV indicates a starting symbol and a length of a first PUSCH occasion of the time domain resource allocation within a slot.
